(19) United States
(12) Patent Application Publication
(10) Pub. No.: US 2025/0039748 A1
(43) Pub. Date: Jan. 30, 2025

(54) METHOD AND APPARATUS FOR EVALUATING CONDITION FOR SEQUENTIAL CONDITIONAL PSCELL CHANGE IN NEXT GENERATION MOBILE COMMUNICATION SYSTEM

(71) Applicant: SAMSUNG ELECTRONICS CO., LTD., Suwon-si (KR)

(72) Inventor: June HWANG, Suwon-si (KR)

(21) Appl. No.: 18/783,346

(22) Filed: Jul. 24, 2024

(30) Foreign Application Priority Data
Jul. 24, 2023 (KR) 10-2023-0095979
Sep. 14, 2023 (KR) 10-2023-0122722

(51) Int. Cl. H04W 36/00; H04W 36/08; H04W 36/36

(52) U.S. Cl. CPC H04W 36/0069; H04W 36/08; H04W 36/362

(57) ABSTRACT

The disclosure relates to a 5G or 6G communication system for supporting a higher data transmission rate.

### CROSS-REFERENCE TO RELATED APPLICATIONS

This application is based on and claims priority under 35 U.S.C. § 119 to Korean Patent Application Nos. 10-2023-0095979 and 10-2023-0122722 filed on Jul. 24, 2023 and Sep. 14, 2023, respectively, in the Korean Intellectual Property Office, the disclosures of which are herein incorporated by reference in their entirety.

### BACKGROUND

### 1. Field

The disclosure relates to operations of a terminal and a base station in a mobile communication system. More specifically, the disclosure relates to a method and an apparatus for performing a sequential conditional PSCell change by a terminal.

### 2. Description of Related Art

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

The disclosure provides a method and an apparatus for performing a sequential PSCell change by a terminal.

In accordance with an aspect of the disclosure, a method performed by a UE in a wireless communication system is provided. The method includes receiving, from a base station, conditional reconfiguration information including candidate target PSCell configuration information for a first target PSCell and at least one SCPAC configuration information corresponding to the first target PSCell; based on the conditional reconfiguration information, identifying whether an execution condition associated with a CPAC for the first target PSCell is fulfilled; and in case that the execution condition associated with the CPAC for the first target PSCell is fulfilled, applying a RRC reconfiguration message for the first target PSCell.

In accordance with an aspect of the disclosure, a method performed by a base station in a wireless communication system is provided. The method includes generating conditional reconfiguration information including candidate target PSCell configuration information for a first target PSCell and at least one SCPAC configuration information corresponding to the first target PSCell; and transmitting, to a user equipment (UE), the conditional reconfiguration information including the candidate target PSCell configuration information for the first target PSCell and the at least one SCPAC configuration information corresponding to the first target PSCell, wherein in case that an execution condition associated with a CPAC for the first target PSCell is fulfilled, a RRC reconfiguration message for the first target PSCell is applied.

In accordance with an aspect of the disclosure, a UE in a wireless communication system is provided. The UE includes a transceiver; and a controller configured to receive, from a base station, conditional reconfiguration information including candidate target PSCell configuration information for a first target PSCell and at least one SCPAC configuration information corresponding to the first target PSCell, based on the conditional reconfiguration information, identify whether an execution condition associated with a CPAC for the first target PSCell is fulfilled, and in case that the execution condition associated with the CPAC for the first target PSCell is fulfilled, apply a RRC reconfiguration message for the first target PSCell.

In accordance with an aspect of the disclosure, a base station in a wireless communication system, is provided. The base station includes a transceiver; and a controller configured to generate conditional reconfiguration information including candidate target PSCell configuration information for a first target PSCell and at least one SCPAC configuration information corresponding to the first target PSCell, and transmit, to a user equipment (UE), the conditional reconfiguration information including the candidate target PSCell configuration information for the first target PSCell and the at least one SCPAC configuration information corresponding to the first target PSCell, wherein in case that an execution condition associated with a CPAC for the first target PSCell is fulfilled, a RRC reconfiguration message for the first target PSCell is applied.

More specifically, the disclosure proposes a configuration provided to the terminal for an operation (subsequent CPAC) of sequentially performing PScell change when a condition is satisfied, and further proposes an operation of the terminal according thereto. Specifically, according to the form in which condition information according to the change to a candidate PSCell is provided to the terminal, the terminal may need to selectively evaluate a condition.

The technical subjects pursued in embodiments of the disclosure may not be limited to the above-mentioned technical subjects, and other technical subjects which are not mentioned may be clearly understood from the following descriptions by those skilled in the art to which the disclosure pertains.

According to an embodiment of the disclosure, a terminal can perform change to an associated PSCell by performing only condition evaluation without indication by a network.

The technical subjects pursued in the disclosure may not be limited to the above mentioned technical subjects, and other technical subjects which are not mentioned may be clearly understood from the following descriptions by those skilled in the art to which the disclosure pertains.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a structure of a long term evolution (LTE) system according to an embodiment of the disclosure;

FIG. 2 illustrates a radio protocol structure of a long term evolution (LTE) system according to an embodiment of the disclosure;

FIG. 3 illustrates a structure of a next-generation mobile communication system according to an embodiment of the disclosure;

FIG. 4 illustrates a radio protocol structure of a next-generation mobile communication system according to an embodiment of the disclosure;

FIG. 5 illustrates a block diagram of a structure of a terminal according to an embodiment of the disclosure;

FIG. 6 illustrates a block diagram of a structure of a base station according to an embodiment of the disclosure;

FIG. 7 illustrates a flow of information according to an embodiment of the disclosure;

FIG. 8 illustrates a condition information configuration method according to an embodiment of the disclosure;

FIG. 9A illustrates a condition information configuration method according to another embodiment of the disclosure;

FIG. 9B illustrates a condition information configuration method according to yet another embodiment of the disclosure;

FIG. 9C illustrates a condition information configuration method according to yet another embodiment of the disclosure;

FIG. 10 illustrates a condition information configuration method according to yet another embodiment of the disclosure;

FIG. 11 illustrates a condition information configuration method according to yet another embodiment of the disclosure;

FIG. 12 illustrates a flow chart of an operation of a terminal according to an embodiment of the disclosure;

FIG. 13 illustrates a flow chart of an operation of a terminal according to another embodiment of the disclosure; and

FIG. 14 illustrates a flow chart of an operation of a terminal according to yet another embodiment of the disclosure.

### DETAILED DESCRIPTION

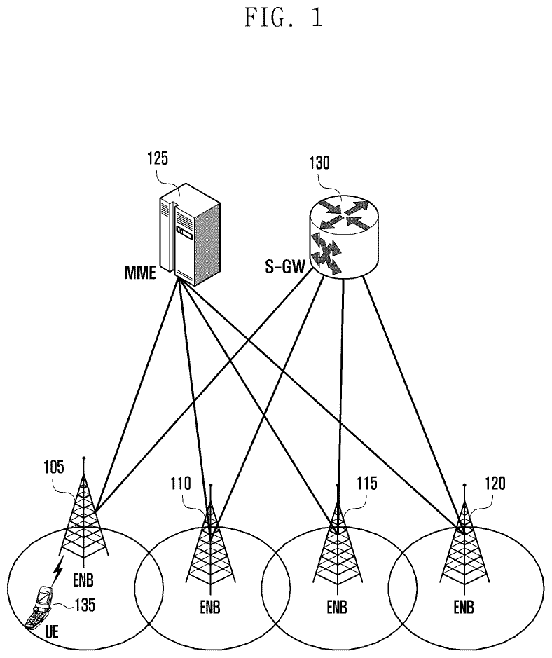

FIGS. 1 through 14, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, the operation principle of the disclosure will be described in detail in conjunction with the accompanying drawings. In describing the disclosure below, a detailed description of known functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In the following description, terms for identifying access nodes, terms referring to network entities, terms referring to messages, terms referring to interfaces between network entities, terms referring to various identification information, and the like are illustratively used for the sake of descriptive convenience. Therefore, the disclosure is not limited by the terms as described below, and other terms referring to subjects having equivalent technical meanings may also be used.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing a communication function. In the disclosure, a “downlink (DL)” refers to a radio link via which a base station transmits a signal to a terminal, and an “uplink (UL)” refers to a radio link via which a terminal transmits a signal to a base station. Furthermore, in the following description, LTE or LTE-A systems may be described by way of example, but the embodiments of the disclosure may also be applied to other communication systems having similar technical backgrounds or channel types. Examples of such communication systems may include the 5th generation mobile communication technologies (5G, new radio, and NR) developed beyond LTE-A, and in the following description, the “5G” may be the concept that covers the exiting LTE, LTE-A, or other similar services. In addition, based on determinations by those skilled in the art, the disclosure may also be applied to other communication systems through some modifications without significantly departing from the scope of the disclosure. Herein, it will be understood that each block of the flowchart illustrations, and combinations of blocks in the flowchart illustrations, can be implemented by computer program instructions.

These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved. As used in embodiments of the disclosure, the “unit” refers to a software element or a hardware element, such as a field programmable gate array (FPGA) or an application specific integrated circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card. Furthermore, the “unit” in embodiments may include one or more processors.

In the following description of the disclosure, terms and names defined in 5GS and NR standards, which are the standards specified by the 3rd generation partnership project (3GPP) group among the existing communication standards, will be used for the sake of descriptive convenience. However, the disclosure is not limited by these terms and names, and may be applied in the same way to systems that conform other standards. For example, the disclosure may be applied to the 3GPP 5GS/NR (5th generation mobile communication standards).

FIG. 1 illustrates a structure of a long term evolution (LTE) system according to an embodiment of the disclosure.

Referring to FIG. 1, as illustrated therein, a radio access network of an LTE system may include next-generation base stations (evolved node Bs, hereinafter ENBs, node Bs, or base stations) 105, 110, 115, and 120, a mobility management entity (MME) 125, and a serving gateway (S-GW) 130. A user equipment (hereinafter a UE or terminal) 135 may access an external network through the ENBs 105 to 120 and the S-GW 130.

In FIG. 1, the ENBs 105 to 120 may correspond to a node B in a UMTS system. The ENBs may be connected to the UE 135 through a radio channel, and perform more complicated roles than the node Bs. In the LTE system, since all user traffic including real-time services, such as voice over IP (VoIP) via the Internet protocol, may be serviced through a shared channel. Thus, a device that collects state information, such as buffer states, available transmit power states, and channel states of UEs, and performs scheduling accordingly is required, and the ENBs 105 to 120 may serve as the device. In general, one eNB may control multiple cells. For example, in order to implement a transfer rate of 100 Mbps, the LTE system may use orthogonal frequency division multiplexing (hereinafter referred to as OFDM) as a radio access technology in a bandwidth of, for example, 20 MHz. Furthermore, the LTE system may employ an adaptive modulation & coding (AMC) scheme for determining a modulation scheme and a channel coding rate according to a channel state of a UE.

The S-GW 130 is a device that provides a data bearer, and may generate or remove a data bearer under the control of the MME 125. The MME is a device responsible for various control functions as well as a mobility management function for a UE, and may be connected to multiple base stations.

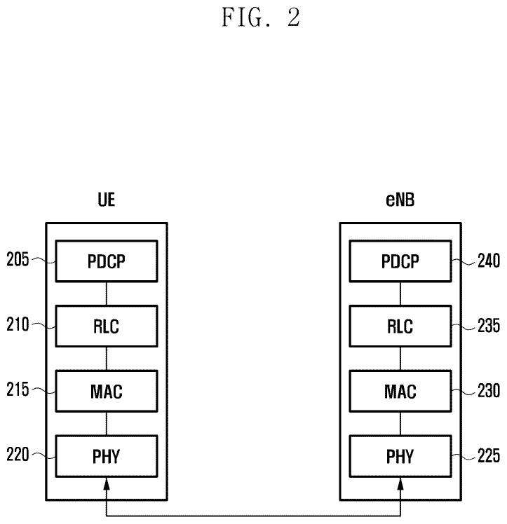

FIG. 2 illustrates a radio protocol structure of an LTE system according to an embodiment of the disclosure.

Referring to FIG. 2, a radio protocol of an LTE system may include a packet data convergence protocol (PDCP) 205 or 240, a radio link control (RLC) 210 or 235, and a medium access control (MAC) 215 or 230 on each of UE and ENB sides.

The PDCP may serve to perform operations such as IP header compression/reconstruction. The main functions of the PDCP may be summarized as follows.
Header compression and decompression: ROHC
Transfer of user data
In-sequence delivery of upper layer PDUs at PDCP re-establishment procedure for RLC AM
For split bearers in DC (support for RLC AM): PDCP PDU routing for transmission and PDCP PDU reordering for reception
Duplicate detection of lower layer SDUs at PDCP re-establishment procedure for RLC AM
Retransmission of PDCP SDUs at handover and, for split bearers in DC, of PDCP PDUs at PDCP data-recovery procedure, for RLC AM
Ciphering and deciphering
Timer-based SDU discard in uplink

The radio link control (RLC) 210 or 235 may reconfigure a PDCP protocol data unit (PDU) into an appropriate size to perform an ARQ operation. The main functions of the RLC may be summarized as follows.
Transfer of upper layer PDUs
Error Correction through ARQ (for AM data transfer)
Concatenation, segmentation and reassembly of RLC SDUs (for UM and AM data transfer)
Re-segmentation of RLC data PDUs (for AM data transfer)
Reordering of RLC data PDUs (for UM and AM data transfer)
Duplicate detection (for UM and AM data transfer)
Protocol error detection (for AM data transfer)
RLC SDU discard (for UM and AM data transfer)
RLC re-establishment

The MAC 215 or 230 may be connected to several RLC layer devices configured in a single terminal, and multiplex RLC PDUs into a MAC PDU and demultiplex a MAC PDU into RLC PDUs. The main functions of the MAC are summarized as follows.
Mapping between logical channels and transport channels
Multiplexing/demultiplexing of MAC SDUs belonging to one or different logical channels into/from transport blocks (TB) delivered to/from the physical layer on transport channels
Scheduling information reporting
Error correction through HARQ
Priority handling between logical channels of one UE
Priority handling between UEs by means of dynamic scheduling
MBMS service identification
Transport format selection
Padding

A physical layer 220 or 225 may perform operations of channel-coding and modulating upper layer data, thereby obtaining OFDM symbols, and delivering the same through a radio channel, or demodulating OFDM symbols received through the radio channel, channel-decoding the same, and delivering the same to the upper layer.

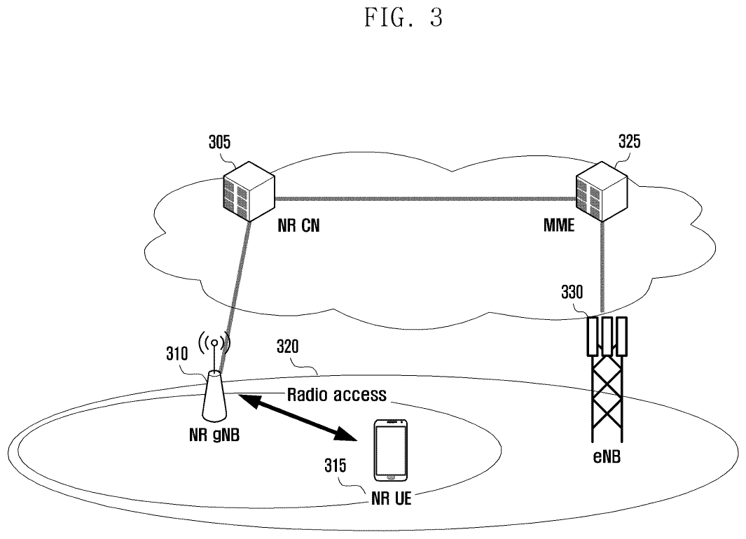

FIG. 3 illustrates a structure of a next-generation mobile communication system according to an embodiment of the disclosure.

Referring to FIG. 3, a radio access network of a next-generation mobile communication system (hereinafter NR or 5G) may include a next-generation base station (new radio node B, hereinafter NR gNB or NR base station) 310, and a new radio core network (NR CN) 305. A new radio user equipment (NR UE or NR terminal) 315 may access an external network via the NR gNB 310 and the NR CN 305.

In FIG. 3, the NR gNB 310 may correspond to an evolved node B (eNB) of an LTE system. The NR gNB may be connected to the NR UE 315 through a radio channel and provide outstanding services as compared to another type of node B. In the next-generation mobile communication system, since all user traffic may be serviced through a shared channel. Thus, a device that collects state information, such as buffer states, available transmit power states, and channel states of UEs, and performs scheduling accordingly is required, and the NR gNB 310 may serve as the device. In general, one NR gNB may control multiple cells. In order to implement ultrahigh-speed data transfer beyond the current LTE, the next-generation mobile communication system may provide a wider bandwidth than the existing maximum bandwidth. In addition, the next-generation mobile communication system may employ an orthogonal frequency division multiplexing (OFDM) as a radio access technology, and may additionally integrate a beamforming technology therewith. Furthermore, the next-generation mobile communication system may employ an adaptive modulation & coding (hereinafter referred to as AMC) scheme for determining a modulation scheme and a channel coding rate according to a channel state of a UE.

The NR CN 305 may perform functions such as mobility support, bearer configuration, and QoS configuration. The NR CN is a device responsible for various control functions as well as a mobility management function for a UE, and may be connected to multiple base stations. In addition, the next-generation mobile communication system may interwork with the existing LTE system, and the NR CN may be connected to an MME 325 via a network interface. The MME may be connected to an eNB 330 that is an existing base station.

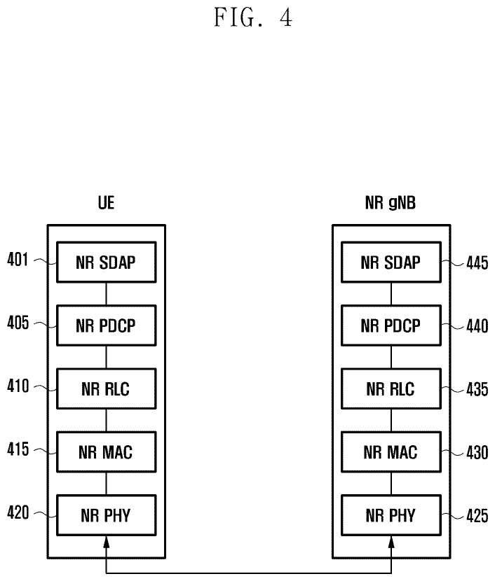

FIG. 4 illustrates a radio protocol structure of a next-generation mobile communication system according to an embodiment of the disclosure.

Referring to FIG. 4, a radio protocol of a next-generation mobile communication system may include an NR service data adaptation protocol (SDAP) 401 or 445, an NR packet data convergence protocol (PDCP) 405 or 440, an NR radio link control (RLC) 410 or 435, and an NR medium access controls (MAC) 415 or 430, on each of UE and NR base station sides.

The main functions of the NR SDAP 401 or 445 may include some of functions below.
Transfer of user plane data
Mapping between a QoS flow and a DRB for both DL and UL
Marking QoS flow ID in both DL and UL packets
Reflective QoS flow to DRB mapping for UL SDAP PDUs

With regard to the SDAP layer device, whether to use the header of the SDAP layer device or whether to use functions of the SDAP layer device may be configured for the UE through an RRC message according to PDCP layer devices or according to bearers or according to logical channels. If an SDAP header is configured, the non-access stratum (NAS) quality of service (QoS) reflection configuration 1-bit indicator (NAS reflective QoS) of the SDAP header and the access stratum (AS) QoS reflection configuration 1-bit indicator (AS reflective QoS) may indicate, to the UE, that the UE can update or reconfigure mapping information regarding the QoS flow and data bearer of the uplink and downlink. The SDAP header may include QoS flow ID information indicating the QoS. The QoS information may be used as data processing priority, scheduling information, etc. for smoothly supporting services.

The main functions of the NR PDCP 405 or 440 may include some of functions below.
Header compression and decompression: ROHC
Transfer of user data
In-sequence delivery of upper layer PDUs
Out-of-sequence delivery of upper layer PDUs
PDCP PDU reordering for reception
Duplicate detection of lower layer SDUs
Retransmission of PDCP SDUs
Ciphering and deciphering
Timer-based SDU discard in uplink

Among the above-described functions, the reordering of the NR PDCP device may refer to a function of reordering PDCP PDU received from a lower layer in an order based on PDCP sequence numbers (SNs). The reordering of the NR PDCP device may include a function of transferring data to an upper layer according to a rearranged order, may include a function of directly transferring data without considering order, may include a function of rearranging order to record lost PDCP PDUs, may include a function of reporting the state of lost PDCP PDUs to a transmission side, and may include a function of requesting retransmission of lost PDCP PDUs.

The main functions of the NR RLC 410 or 435 may include some of functions below.
Transfer of upper layer PDUs
In-sequence delivery of upper layer PDUs
Out-of-sequence delivery of upper layer PDUs
Error Correction through ARQ
Concatenation, segmentation and reassembly of RLC SDUs
Re-segmentation of RLC data PDUs
Reordering of RLC data PDUs
Duplicate detection
Protocol error detection
RLC SDU discard
RLC re-establishment

Among the above-described functions, the in-sequence delivery of the NR RLC device may refer to a function of delivering RLC SDUs, received from the lower layer, to the upper layer in sequence. If one original RLC SDU is divided into several RLC SDUs and the RLC SDUs are received, the in-sequence delivery function of the NR RLC device may include a function of reassembling the several RLC SDUs and transferring the reassembled RLC SDUs.

The in-sequence delivery function of the NR RLC device may include a function of rearranging received RLC PDUs with reference to RLC sequence numbers (SNs) or PDCP sequence numbers (SNs), may include a function of rearranging order to record lost RLC PDUs, may include a function of reporting the state of lost RLC PDUs to a transmission side, and may include a function of requesting retransmission of lost RLC PDUs.

The in-sequence delivery of the NR RLC device may refer to a function of, if there is a lost RLC PDU, delivering RLC SDUs before the lost RLC PDU to the upper layer in sequence.

The in-sequence delivery of the NR RLC device may include a function of, although there is a lost RLC SDU, if a predetermined timer has expired, sequentially transferring, to a higher layer, all the RLC SDUs received before the timer is started.

The in-sequence delivery of the NR RLC device may include a function of, although there is a lost RLC SDU, if a predetermined timer has expired, sequentially transferring all the RLC SDUs received up to the current, to a higher layer.

The NR RLC device may process RLC PDUs in a reception sequence, regardless of a sequence based on sequence numbers (out-of-sequence delivery). and then deliver the processed RLC PDUs to the NR PDCP device.

If receiving segments, the NR RLC device may receive segments stored in a buffer or to be received in the future, reconfigure the segments into one whole RLC PDU, process the RLC PDU, and then deliver the processed RLC PDU to the NR PDCP device.

The NR RLC layer may not include a concatenation function, but the concatenation function may be performed in the NR MAC layer or replaced with a multiplexing function of the NR MAC layer.

Among the above-described functions, the out-of-sequence delivery of the NR RLC device may refer to a function of instantly delivering RLC SDUs received from the lower layer to the upper layer regardless of the order. The in-sequence delivery of the NR RLC device may include a function of, if one original RLC SDU is segmented into multiple RLC SDUs and the segmented RLC SDUs are received, reassembling the RLC SDUs and delivering the reassembled RLC SDUs. The out-of-sequence delivery function of the NR RLC device may include a function of storing an RLC sequence number (SN) or a PDCP sequence number (SN) of received RLC PDUs and arranging the order thereof to record lost RLC PDUs.

The NR MAC 415 or 430may be connected to multiple NR RLC layer devices configured in one UE, and the main functions of the NR MAC may include some of functions below.
Mapping between logical channels and transport channels
Multiplexing/demultiplexing of MAC SDUs
Scheduling information reporting
Error correction through HARQ
Priority handling between logical channels of one UE
Priority handling between UEs by means of dynamic scheduling
MBMS service identification
Transport format selection
Padding

An NR PHY 420 or 425 may perform operations of channel-coding and modulating upper layer data, thereby obtaining OFDM symbols, and delivering the same through a radio channel, or demodulating OFDM symbols received through the radio channel, channel-decoding the same, and delivering the same to the upper layer.

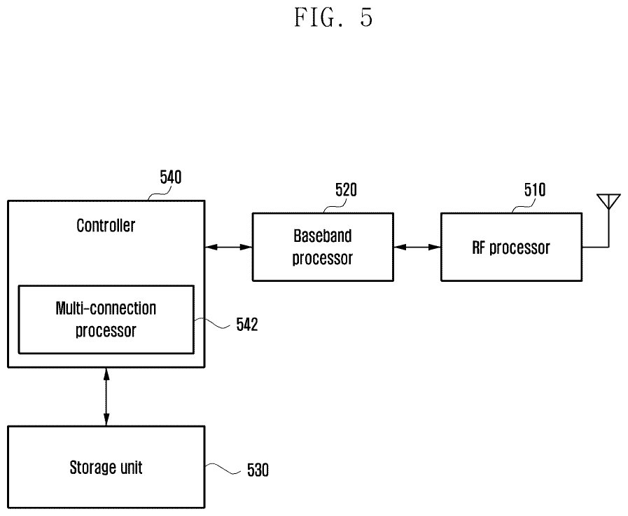

FIG. 5 illustrates a block diagram of a structure of a terminal according to an embodiment of the disclosure.

As illustrated in the diagram, the terminal may include a radio frequency (RF) processor 510, a baseband processor 520, a storage 530, and a controller 540.

The RF processor 510 performs a function for transmitting or receiving a signal through a wireless channel, such as signal band conversion, amplification, and the like. The RF processor 510 up-converts a baseband signal provided from the baseband processor 520 into an RF band signal, transmits the same through an antenna, and down-converts an RF band signal received through the antenna into a baseband signal. For example, the RF processor 510 may include a transmission filter, a reception filter, an amplifier, a mixer, an oscillator, a digital-to-analog converter (DAC), an analog-to-digital converter (ADC), and the like. Although only one antenna is illustrated in the diagram, the terminal may include multiple antennas. In addition, the RF processor 510 may include multiple RF chains. Moreover, the RF processor 510 may perform beamforming. For the beamforming, the RF processor 510 may adjust the phase and magnitude of each of signals transmitted or received through multiple antennas or antenna elements. In addition, the RF processor may perform MIMO, and receive serval layers while performing an MIMO operation.

The baseband processor 520 performs a function of conversion between a baseband signal and a bit string according to a physical layer specification of a system. For example, during data transmission, the baseband processor 520 encodes and modulates a transmission bit string, thereby generating complex symbols. In addition, during data reception, the baseband processor 520 demodulates and decodes a baseband signal provided from the RF processor 510, thereby restoring a reception bit string. For example, when an orthogonal frequency division multiplexing (OFDM) scheme is followed, during data transmission, the baseband processor 520 encodes and modulates a transmission bit string so as to generate complex symbols, maps the complex symbols to subcarriers, and then configures OFDM symbols through an inverse fast Fourier transform (IFFT) operation and cyclic prefix (CP) insertion. In addition, during data reception, the baseband processor 520 divides a baseband signal provided from the RF processor 510 in units of OFDM symbols, restores signals mapped to subcarriers through fast Fourier transform (FFT), and then restores the reception bit string through demodulation and decoding.

The baseband processor 520 and the RF processor 510 transmit and receive signals as described above. Accordingly, the baseband processor 520 and the RF processor 510 may be referred to as a transmitter, a receiver, a transceiver, or a communication unit. Moreover, at least one of the baseband processor 520 and the RF processor 510 may include different communication modules in order to support multiple different wireless access technologies. In addition, at least one of the baseband processor 520 and the RF processor 510 may include different communication modules in order to process signals in different frequency bands. For example, support multiple different wireless access technologies may include a wireless RAN (e.g., IEEE 802.11), a cellular network (e.g., LTE), etc. For example, the different frequency bands may include a super high frequency (SHF) (for example, 2. NRHz, NRhz) band and a millimeter (mm) wave (for example, 60 GHz) band.

The storage 530 stores data for operation of the terminal, such as a basic program, an application program, and configuration information. Specifically, the storage 530 may store information related to a second access node for performing wireless communication by using a second wireless access technology. In addition, the storage 530 provides stored data upon a request of the controller 540.

The controller 540 controls the overall operations of the terminal. For example, the controller 540 receives or transmits signals through the baseband processor 520 and the RF processor 510. In addition, the controller 540 records and reads data in and from the storage 530. To this end, the controller 540 may include at least one processor. For example, the controller 540 may include a communication processor (CP) that performs control for communication, and an application processor (AP) that controls the upper layer, such as an application program.

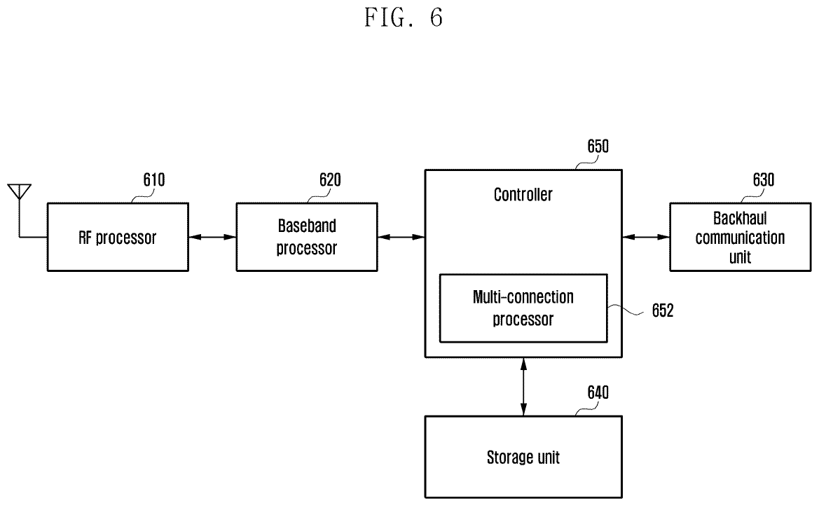

FIG. 6 illustrates a block diagram of a structure of a base station according to an embodiment of the disclosure.

As illustrated in the diagram, the base station includes an RF processor 610, a baseband processor 620, a backhaul communication unit 630, a storage 640, and a controller 650.

The RF processor 610 performs a function for transmitting or receiving a signal through a wireless channel, such as signal band conversion, amplification, and the like. The RF processor 610 up-converts a baseband signal provided from the baseband processor 620 into an RF band signal, transmits the same through an antenna, and down-converts an RF band signal received through the antenna into a baseband signal. For example, the RF processor 610 may include a transmission filter, a reception filter, an amplifier, a mixer, an oscillator, a DAC, an ADC, and the like. Although only one antenna is illustrated in the diagram, a first access node may include multiple antennas. In addition, the RF processor 610 may include multiple RF chains. Moreover, the RF processor 610 may perform beamforming. For the beamforming, the RF processor 610 may adjust the phase and magnitude of signals transmitted/received through multiple antennas or antenna elements. The RF processor may perform a downlink MIMO operation by transmitting at least one layer.

The baseband processor 620 performs a function of conversion between a baseband signal and a bit string according to the physical layer specification of the first radio access technology. For example, during data transmission, the baseband processor 620 encodes and modulates a transmission bit string, thereby generating complex symbols. In addition, during data reception, the baseband processor 620 demodulates and decodes a baseband signal provided from the RF processor 610, thereby restoring a reception bit string. For example, when an OFDM scheme is followed, during data transmission, the baseband processor 620 encodes and modulates a transmission bit string so as to generate complex symbols, maps the complex symbols to subcarriers, and then configures OFDM symbols through an IFFT operation and CP insertion. In addition, during data reception, the baseband processor 620 divides a baseband signal provided from the RF processor 610 in units of OFDM symbols, restores signals mapped to subcarriers through a fast Fourier transform (FFT) operation, and then restores the reception bit string through demodulation and decoding. The baseband processor 620 and the RF processor 610 transmit and receive signals as described above. Accordingly, the baseband processor 620 and the RF processor 610 may be referred to as a transmitter, a receiver, a transceiver, a communication unit, or a wireless communication unit.

The backhaul communication unit 630 provides an interface for communicating with other nodes inside the network. The backhaul communication unit 630 converts a bit string transmitted from the main base station to another node, for example, an auxiliary base station or a core network, into a physical signal, and converts a physical signal received from the other node into a bit string.

The storage 640 stores data for operation of the main base station, such as a basic program, an application program, and configuration information. Specifically, the storage 640 may store information regarding a bearer allocated to an accessed terminal, a measurement result reported from the accessed terminal, and the like. In addition, the storage 640 may store information serving as a criterion to determine whether to provide the terminal with multi-connection or discontinue the same. In addition, the storage 640 provides stored data upon a request of the controller 650.

The controller 650 controls the overall operations of the main base station. For example, the controller 650 receives or transmits signals through the baseband processor 620 and the RF processor 610, or through the backhaul communication unit 630. In addition, the controller 650 records and reads data in and from the storage 640. To this end, the controller 650 may include at least one processor.

The disclosure may include the following terminology.
MN: indicates a master node.
SN: indicates a secondary node.
CPAC: indicates conditional PSCell addition and change, i.e., indicates a function that a terminal can add a related PSCell or change to the related PSCell when a specific condition is satisfied.
subsCPAC: indicates subsequent CPAC, i.e., the subsequent CPAC indicates a function that a terminal subsequently performs a corresponding CPAC operation even after change to a specific PSCell without a separate network configuration operation.

According to an embodiment of the disclosure, a condition configuration method for a conditional PSCell change operation is proposed. Specifically, a method for configuring a condition for performing an operation when the terminal performs a consecutive conditional PSCell change operation is proposed.

Typically, only a condition for changing to candidate target cells from a source cell in a determined state. In the disclosure, when a condition associated with one candidate target cell is transferred regardless of a current source cell, a method and a device for configuring a source cell to be used as a reference when selecting a condition are provided. Specifically, when multiple conditions are given, during evaluation of a condition of a subsCPAC operation, a configuration method may vary according to a source cell to be used as a reference when selecting a condition.

In the disclosure, several sub issues and solution options for each of the issues are proposed. Consequently, the terminal may operate by applying one of the solutions proposed for each of the issues, or may operate through operation variation through a combination of multiple operations.

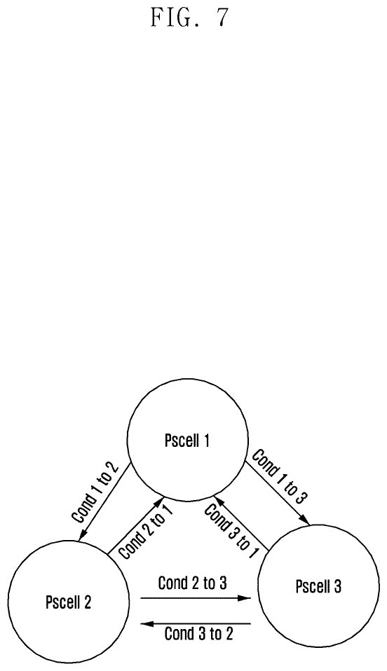

FIG. 7 illustrates a flow of information according to an embodiment of the disclosure.

More specifically, referring to FIG. 7, information to be transferred (or transmitted) to the terminal is illustrated.

When target PSCells are determined by candidate SNs, respectively, the corresponding SNs need to also determine a condition used when changing to other candidate PSCell from the corresponding target PSCell.

As illustrated in FIG. 7, a detailed condition for performing PSCell change may be as follows.
Condition for change from PSCell 1 to PSCell2: Cond 1 to 2
Condition for change from PSCell 1 to PSCell3: Cond 1 to 3
Condition for change from PSCell 2 to PSCell1: Cond 2 to 1
Condition for change from PSCell 2 to PSCell3: Cond 2 to 3
Condition for change from PSCell 3 to PSCell1: Cond 3 to 1
Condition for change from PSCell 3 to PSCell2: Cond 3 to 2

A network (or base station) may collect at least one piece of information among the pieces of information, and an MN may transfer, to the terminal, configuration information of the target PSCells and all associated pieces of condition information. In this case, the following problems may occur according to a relationship of each target PSCell transferred to the terminal and an associated condition.

Issue 1: A structure of information configured and indicated for the terminal varies according to a relationship between a condition and a target cell configuration given to the terminal.

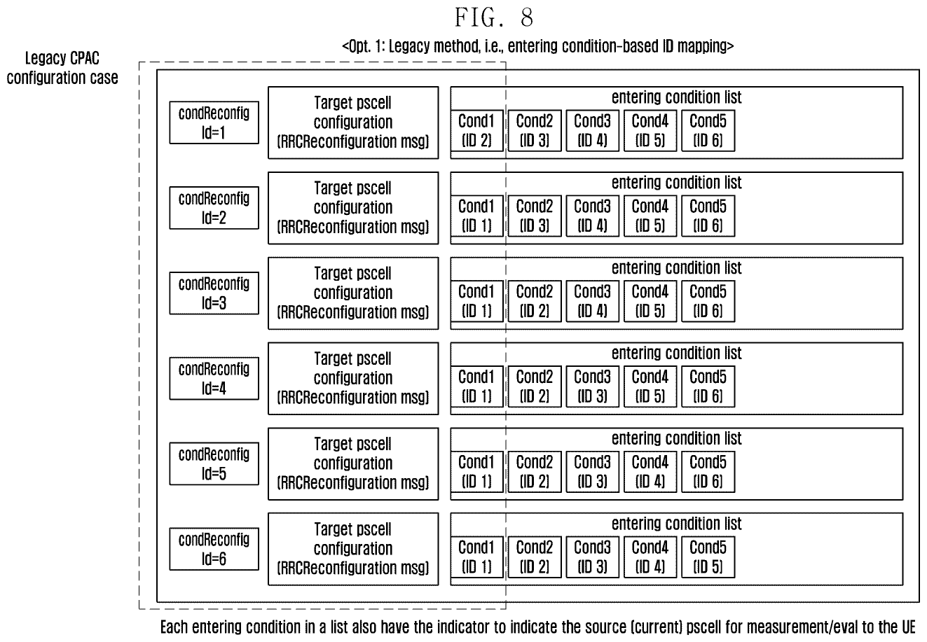

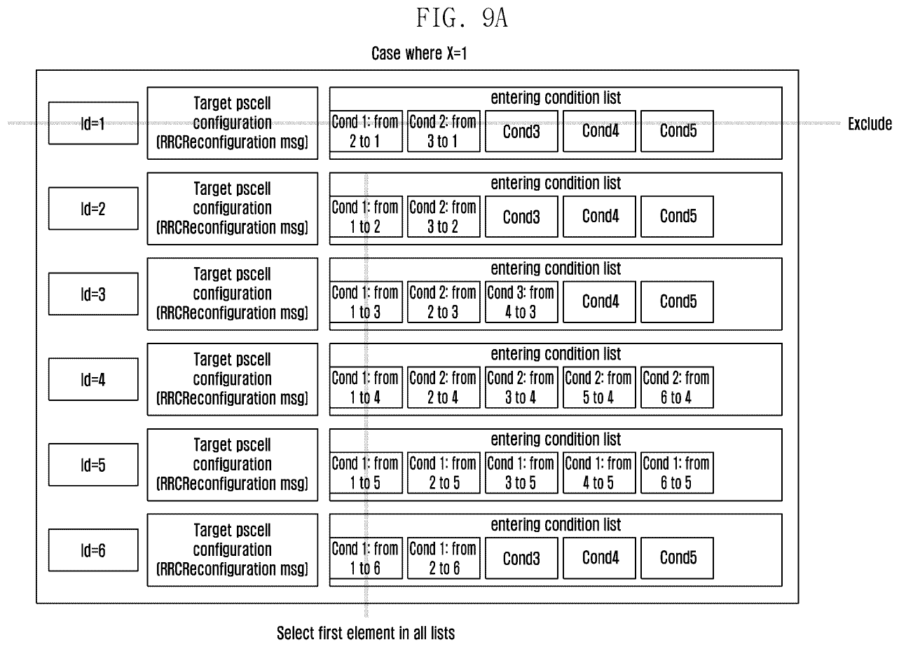

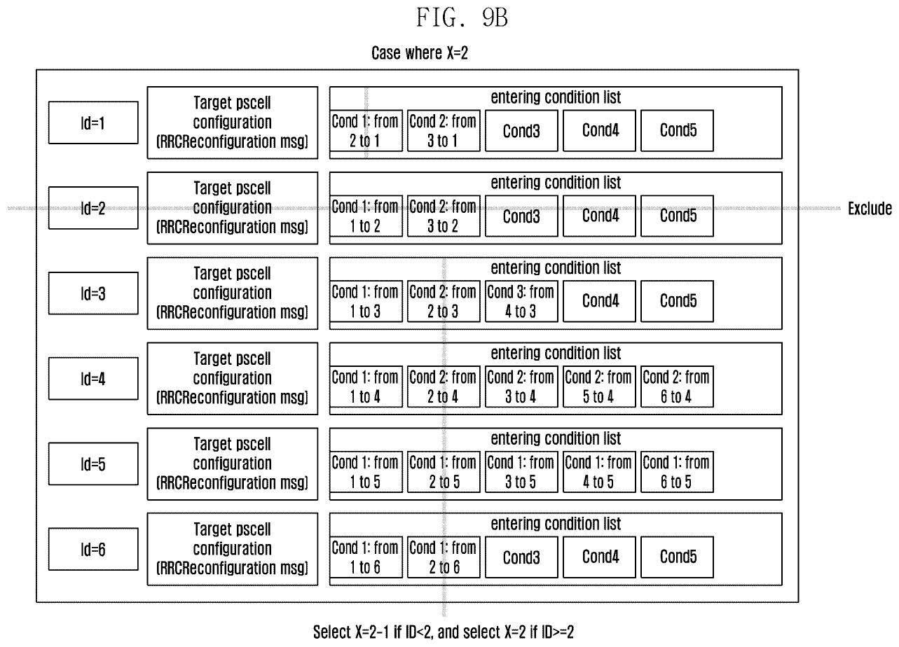

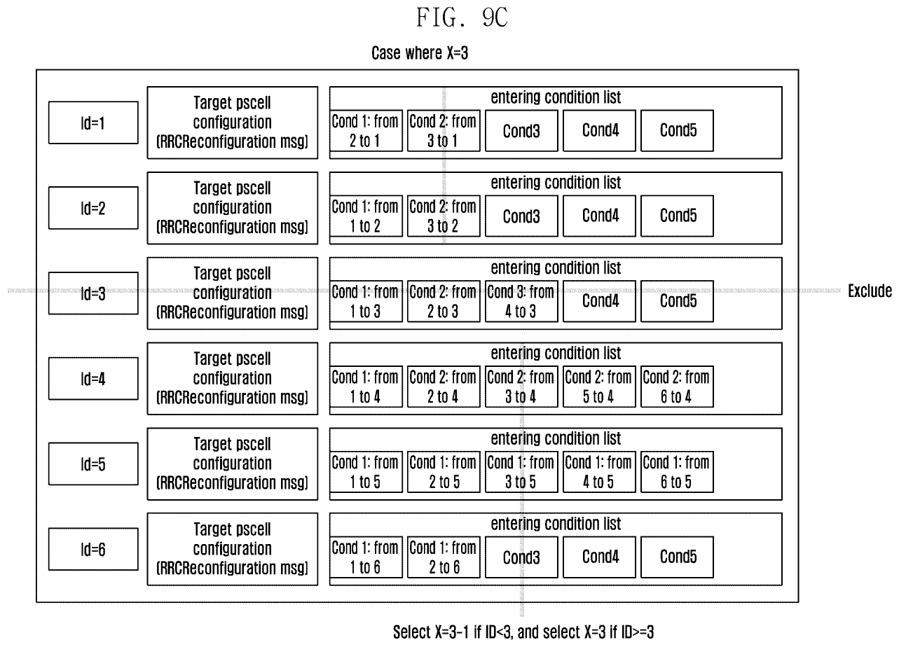

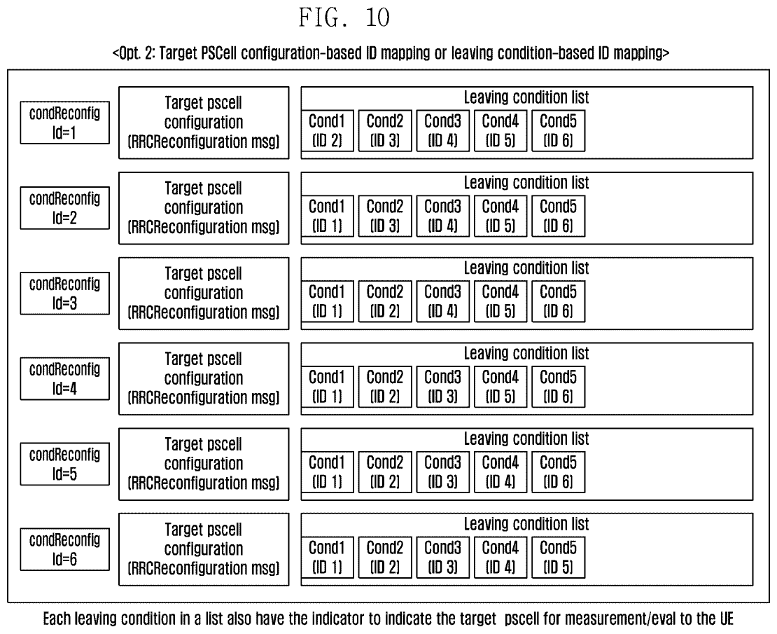

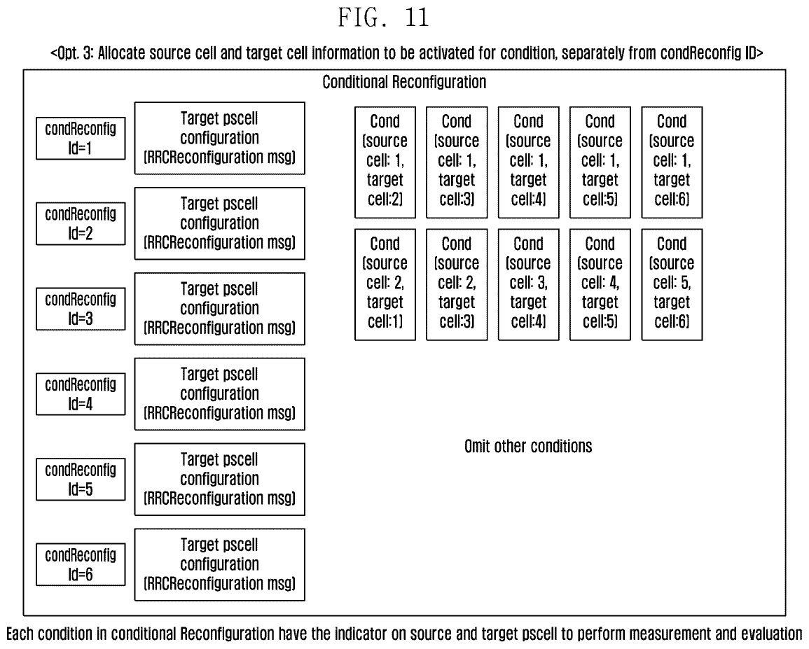

Hereinafter, to resolve Issue 1, Option 1, Option 2, and Option 3 are proposed. More specifically, Option 1 is described in detail with reference to FIGS. 8 and 9, Option 2 is described in detail with reference to FIG. 10, and Option 3 is described in detail with reference to FIG. 11.

Commonly in the Options below, when a network transmits (or transfers) a subsCPAC configuration (or subsCPAC-config) to the terminal, candidate target PSCell configuration information (for example, an RRCReconfiguration message) and performing conditions associated with the corresponding target PSCell are associated in a subsCPAC configuration-related field and transmitted (or transferred). In addition, a specific ID for referring to this association may be allocated. For convenience of description, this ID is referred to as a condReconfig ID.

Opt 1. The condReconfig ID may be associated with candidate target PSCell configuration information and pieces of condition information (so called entering condition) for change to the corresponding PSCell, and has the following characteristics.
There is a similarity with a legacy signaling structure, i.e., in a structure of a signal of the legacy CPAC, a target PSCell and condition information to be satisfied for change to the target PSCell are associated.
At the time of a configuration, whether the configuration is received to a current PSCell is not directly associated. Thereafter, a required condition may be filtered out.
The terminal may receive a configuration including the structure, e.g., conditional reconfiguration for SCPAC field, and store the corresponding information for each ID.
   Information associated using an ID (e.g., condReconfig Id) and stored includes one candidate target PSCell configuration (RRCReconfiguration message) and a list of entering conditions.
      An entering condition means a condition to be satisfied when a change to a candidate target PSCell associated using the ID (condReconfig Id), measurement/evaluation may be made by selecting a specific condition among multiple entering conditions according to “a PSCell to which serving is currently provided, i.e., a source PSCell at a subsCPAC performance (or evaluation) time point” at “a time point of receiving the configuration and/or a time point after applying the RRCReconfiguration message for subsCPAC performance after the reception of the configuration”.
         As a method for indicating that the multiple entering conditions corresponding to condition information to be used by the terminal by considering a specific PSCell as a source, options below are possible.
         Opt 1-1: A separate ID is introduced to each element of a list of enter conditions corresponding to each condReconfig ID. This ID may have an integer value. For example, a condReconfig ID may be used as an ID mapped to each element of the list of entering conditions. In this case, a specific source PSCell of this element indicates a PSCell on the target PSCell configuration associated with the condReconfig ID.
         Opt 1-2: Source PSCell information is introduced to each element of a list of enter conditions corresponding to each condReconfig ID. Rather than a separate explicit ID, order information in the list may be used instead of the ID.
         Opt 1-3: Source PSCell information to be activated is introduced to each element of a list of enter conditions corresponding to each condReconfig ID. This information may be absolute radio frequency channel number (ARFCN) or frequency information of the corresponding PSCell and/or physical cell identity (PCI) or cell group identity (CGI) information.

FIG. 8 illustrates a condition information configuration method according to an embodiment of the disclosure.

More specifically, FIG. 8 is related to Opt 1-1 of the above-described condition information configuration method according to Opt 1.

According to the Opt 1-1 method, the condReconfig ID may be configured by (may associated or include) a target PSCell configuration and a list of conditions. In this case, the condition, as an entering condition, may mean a condition used during change to an associated target PSCell. Additionally for each condition, information on a source PSCell in which the condition is to be used may need to be notified to the terminal. In a case of a configuration of the existing CPAC, the condReconfig ID, the target PSCell configuration, and one condition (which may include multiple measIds therein) are bundled as one. In this case, the condition information is just a condition in a case of change to the target PSCell when a PSCell of the current terminal is used as a source, and thus separate source cell information is not required for the condition information.

In Opt 1-1, each element of the list may be mapped to an ID of an integer. The ID mapped to the element of the list may mean a source cell ID of condition information used when changing to the target PSCell mapped to the condReconfigID from a specific source cell.

More specifically, the condReconfigID may be associated with one target PSCell configuration and an (entering) condition list, and the (entering) condition list may include one or more conditions (e.g., Cond1, Cond2, Cond3, . . . ). In this case, an ID corresponding to a source PSCell may be mapped to each condition (e.g., Cond1, Cond2, Cond3, . . . ). Accordingly, when a subsequence CPAC condition is determined by using, as a source PSCell, a cell corresponding to an ID configured for each of the conditions and using, as a target PSCell, a cell corresponding to the condReconfig ID, the subsequence CPAC condition may be determined by applying the condition corresponding to the source cell ID.

The network may allocated the source cell ID according to a determined rule, and notify the terminal of the information. For example, to refer to all candidate target PSCells, the condReconfig ID is allocated to each candidate target PSCell, and thus the condReconfig ID may be used as the source cell id.

Referring to FIG. 8, the first condition (Cond1) of a condition list corresponding to (included in) condReconfig ID 1 is indicated as ID 2. Accordingly, the first condition (Cond1) is a condition to be satisfied when performing changing (e.g., PSCell addition and change (CPAC)) when using, as a source cell, a PSCell corresponding to condReconfig ID 2, and using, as a target cell, a PSCell corresponding to condReconfig ID 1.

In another example, in FIG. 8, the third condition (Cond3) of the condition list corresponding to condReconfig ID 4 is indicated as ID 3. Accordingly, the third condition (Cond3) of the condition list corresponding to condReconfig ID 4 is a condition to be satisfied when performing changing (e.g., PSCell addition and change (CPAC)) when using, as a source cell, a PSCell corresponding to condReconfig ID 3, and using, as a target cell, a PSCell corresponding to condReconfig ID 4.

The terminal moves between PSCells indicated by the condReconfig IDs, and thus the terminal may perform condition evaluation by selecting a condition in which a current PSCell of the terminal is indicated as a source PSCell from among the elements of the entering condition list.

FIG. 9A illustrates a condition information configuration method according to another embodiment of the disclosure, FIG. 9B illustrates a condition information configuration method according to yet another embodiment of the disclosure, and FIG. 9C illustrates a condition information configuration method according to yet another embodiment of the disclosure.

More specifically, FIGS. 9A to 9C illustrate a method for selecting a condition to be evaluated according to a current PSCell by a terminal in the cape of Opt 1-2.

According to Opt 1-2, instead of allocating (or mapping) an integer ID (e.g., a source cell ID using a condReconfig ID) for each element of the list (e.g., Cond1, Cond2, Cond3, . . . ), sequence information or an order on the list may be used for ID mapping.

When an indicated source cell of the element of the list is all indicated by the condReconfigID and the terminal is in a specific source cell, cells remaining after excluding the corresponding source cell may be a target cell during change (e.g., PSCell addition and change (CPAC)). Accordingly, a maximum number of elements of all list is (a maximum PSCell number−1) specified by the condReconfig ID.

According to an embodiment of the disclosure, source cell mapping of the element of the list may be performed by mapping the earliest cell indicated by the condReconfig 1D so that the earliest cell in order is first mapped, and a target PSCell indicated by the current condReconfig ID may be excluded from the source cell target.

For example, if the order of one element of a condition list of condReconfig ID=X is N and N<X, N may indicate a PSCell having condReconfig ID=N as a source PSCell. If N>=X, N may indicate a PScell having condReconfig ID=N+1 as a source PSCell. Accordingly, when a configuration is given, the terminal may find a condition in which the current PSCell is indicated as a source PSCell on the list for each condReconfig id, and evaluate the corresponding condition.

Referring to FIG. 9A (the case of X=1), when the current cell is identical of condReconfig ID=1, the terminal may exclude conditions (i.e., all conditions associated with condReconfig ID=1) of the first row. Conditions that the current PSCell, i.e., the PSCell having condReconfig ID=1, is indicated as a source cell, may be selected from among the conditions associated the remaining IDs. Accordingly, the first conditions of each condition list may be selected as evaluation targets.

Referring to FIG. 9B (the case of X=2), when the current PSCell is identical to condReconfig ID=2, the terminal may first exclude conditions on the row associated with the corresponding condReconfig ID=2. A condition evaluation may be performed by selecting the first condition in a case of a condition list having condReconfig ID <2 and selecting the second conditions in a case of condition lists having the remaining condReconfig IDs.

Similar to the case of FIG. 9C (the case of X=3), a cell having condReconfig ID=3 is the current PSCell, and thus a condition evaluation may be performed by selecting the second conditions of the condition lists having condReconfig ID=1 and condReconfig ID=2 and selecting the second conditions of the condition lists having condRefconfig ID >=3.

Although not shown, in Opt 1-3, each element of the list (e.g., Cond1, Cond2, . . . of the entering condition list illustrated in FIGS. 8 and 9) may use objective cell information as information indicating a source PSCell. That is, as the information indicating the source PScell, one or more of a physical cell identity (PCI), an absolute radio frequency channel number (AFRCN), a cell group identity (CGI), a frequency, and a measurement object ID may be associated and indicated.

Accordingly, when a configuration is given, the terminal may find a condition in which the current PSCell is indicated as a source PScell on the condition list for each condReconfig id, and evaluate the corresponding condition.

FIG. 10 illustrates a condition information configuration method according to yet another embodiment of the disclosure.

More specifically, in the above-described condition indication method, an entering condition is associated with a target PSCell in Opt 1, but in Opt 2, a method for associating a target PSCell and a leaving condition is proposed. Specifically, FIG. 10 is related to Opt 2-1 among the condition information configuration methods according to Opt 2 to be described below.

Opt 2. A condReconfig ID is associated with candidate target PSCell configuration information and condition information (so called a leaving condition) for change to another candidate PSCell from the corresponding PSCell. To this end, FIG. 10 may be referred to, and Opt 2 has the following characteristics.
A new structure
The terminal receives a configuration including the structure, i.e., a conditional reconfiguration for an SCPAC field, and stores the corresponding information for each ID.
   The information, which is associated with the ID and stored, may be one candidate target PSCell configuration (may be an RRCReconfiguration message), and may be a list of leaving conditions.
      A leaving condition means a condition in which evaluation can be performed after changing to a candidate target PSCell associated with the ID. That is, the leaving condition considers the PSCell on the associated condReconfig ID as a source PSCell. According to a current PSCell to which serving is currently provided at “a time point of reception of the configuration and/or a time point after applying the RRCReconfiguration message for performing subsCPAC after the reception of the configuration, the list of leaving conditions corresponding to the condReconfig ID upon the current PSCell may be measured and/or evaluated.
         The multiple leaving conditions are conditions to be used when the terminal is served to a target PSCell associated with the corresponding condReconfig ID (i.e., in a case of a source PSCell). However, each of the conditions still may need target PSCell information. Accordingly, a method for indicating condition information to be used when changing to a specific target PSCell is required, and options below are possible.
         Opt 2-1: A separate ID is introduced to each element of a list of leaving conditions corresponding to each condReconfig ID. This ID may have an integer value. For example, a condReconfig ID may be used as an ID mapped to each element of the list of leaving conditions. In this case, a target PSCell of this element is a target PSCell associated with the indicated condReconfig ID.
         Opt 2-2: Instead of introducing an explicit ID to each element of the list of leaving conditions corresponding to each condReconfig ID, a target PSCell may be indicated as order information of each element in the list. During applicable cell identification, a cell including condRRCReconfig according to the target PSCell information, i.e., reconfigurationWithSync at an SCG configuration part of target PSCell configuration, is recognized as an application cell,
         Opt 2-3: Target PSCell information is introduced to each element of a list of entering conditions corresponding to each condReconfig ID. This information may be absolute radio frequency channel number (ARFCN) or frequency information of the corresponding PSCell and/or physical cell identity (PCI), cell group identity (CGI), and/or measurement object ID information. During applicable cell identification, a cell including condRRCReconfig according to the target PSCell information, i.e., reconfigurationWithSync at an SCG configuration part of the target PSCell configuration information, is recognized as an applicable cell.

According to this method, the condReconfig ID may be configured by (may associate or include) a target PSCell configuration and a list of conditions. Here, the condition indicates a leaving condition, and may mean a condition used during change to another PSCell from an associated target PSCell. For each condition, information on a target PSCell in which the condition is to be used may need to be additionally notified to the terminal.

In Opt 2-1, for each condReconfig ID, the element of the list may be mapped to an ID of an integer. Here, the ID mapped to the element of the list with an integer may mean a target PSCell for which the corresponding condition is used when changing to a specific target PSCell from a current PSCell.

More specifically, the condReconfigID may be associated with one target PSCell configuration and a (leaving) condition list, and the (leaving) condition list may include one or more conditions (e.g., Cond1, Cond2, Cond3, . . . ). In this case, an ID corresponding to a target PSCell may be mapped to each condition (e.g., Cond1, Cond2, Cond3, . . . ). Accordingly, when a subsequence CPAC condition is determined by using, as a target PSCell, a cell corresponding to an ID configured for each of the conditions and using, as a source PSCell, a cell corresponding to the condReconfig ID, the subsequence CPAC condition may be determined by applying the condition corresponding to the target cell ID.

The network may allocated the target cell ID according to a determined rule, and notify the terminal of the information. For example, to refer to all candidate target PSCells, the condReconfig ID is allocated to each candidate target PSCell, and thus the condReconfig ID may be used as the target cell ID.

Referring to FIG. 10, the first condition (Cond1) of a condition list corresponding to (included in) condReconfig ID 1 is indicated as ID 2. Accordingly, the first condition (Cond1) is a condition to be satisfied when performing changing (e.g., PSCell addition and change (CPAC)) when using, as a target cell, a PSCell corresponding to condReconfig ID 2, and using, as a source cell, a PSCell corresponding to condReconfig ID 1.

In another example, in FIG. 10, the fifth condition (Cond5) of the condition list corresponding to condReconfig ID 5 is indicated as ID 6. Accordingly, the fifth condition (Cond5) of the condition list corresponding to condReconfig ID 5 is a condition to be satisfied when performing changing (e.g., PSCell addition and change (CPAC)) when using, as a target cell, a PSCell corresponding to condReconfig ID 6, and using, as a source cell, a PSCell corresponding to condReconfig ID 5.

When receiving conditional reconfiguration for SCPAC configuration, the terminal identifies a current PSCell and considers a condReconfig ID having the current PSCell as a target PSCell. All conditions on the (leaving) condition list associated with this ID may be measured and the condition evaluation thereof may be performed. The (leaving) condition lists associated with the other IDs are not measured and the condition evaluation thereof is not performed.

Among the conditions for which measurement evaluation is performed, the terminal may identify that a target PSCell to which the PSCell is changed is made when each condition is satisfied is a target PSCell having a condReconfig ID indicated by an ID allocated to each condition. Accordingly, when a satisfied condition occurs among the conditions to be evaluated, applying (i.e., changing to the corresponding PSCell) CPAC configuration to a target PSCell associated with the corresponding condition may be performed. The same operation may be applied to the corresponding changed PSCell after performing the subsequence CPAC operation.

Although not shown, according to Opt 2-2, instead of allocating (or mapping) an integer ID (e.g., a target cell ID using a condReconfig ID) for each element of the list (e.g., Cond1, Cond2, Cond3, . . . ), sequence information or an order on the list may be used for ID mapping.

When an indicated target cell of the element of the list is all indicated by the condReconfigID and the terminal is in a specific source cell, cells remaining after excluding the corresponding source cell may be a target cell during change (e.g., PSCell addition and change (CPAC)). Accordingly, a maximum number of elements of all list is (a maximum PSCell number−1) specified by the condReconfig ID.

According to an embodiment of the disclosure, target cell mapping of the element of the list may be performed by mapping the earliest cell indicated by the condReconfig ID so that the earliest cell in order is first mapped, and a target PSCell indicated by the current condReconfig 1D may be excluded from the target cell target.

For example, if the order of one element of a condition list of condReconfig ID=X is N and N<X, N may indicate a PSCell having condReconfig ID=N as a target PSCell. If N>=X, N may indicate a PScell having condReconfig ID=N+1 as a target PSCell. When configuration information is given in a conditional reconfiguration field, the terminal may identify a current PSCell, and for the current PSCell having the same ID as that of the target PSCell having the condReconfig ID, for the list of conditions, measurement and condition evaluation may be performed.

In addition, for the target P SCell allocated to each of the conditions, if a condition that is being evaluated is satisfied, conditional PSCell addition and change to the target PSCell may be performed.

Although not shown, in Opt 2-3, each element of the list (e.g., Cond1, Cond2, . . . of the entering condition list illustrated in FIG. 10) may use objective cell information as information indicating a target PSCell. That is, the information indicating the target PScell may be associated with one of a physical cell identity (PCI), an absolute radio frequency channel number (AFRCN), a cell group identity (CGI), a frequency, and a measurement object ID, and indicated.

Accordingly, when a configuration is given or after CPAC to a specific PSCell is performed, the terminal may find an ID by which a current PSCell at the time point is indicated as a target PSCell on the condReconfig ID, and for the list of conditions associated with the ID, condition evaluation may be performed. For the list of conditions associated with other condReconfig IDs, measurement and condition evaluation are not performed.

FIG. 11 illustrates a condition information configuration method according to yet another embodiment of the disclosure.

More specifically, FIG. 11 illustrates configuration information on a conditional reconfiguration for an SCPAC field according to option 3. As a condition indication method, Opt 3 proposes a method for separately allocating an source PSCell ID and a target PSCell ID in a case where the corresponding condition is to be used for each piece of condition information.

More specifically, when a network transmits a conditional reconfiguration for SCPAC to the terminal, the conditional reconfiguration for SCPAC may include a condReconfig 1D and candidate target PSCell configuration information (e.g., an RRCReconfiguration message) corresponding to the condReconfig ID. In addition, the conditional reconfiguration for SCPAC may include one or more pieces of condition information including a source PSCell ID and a target PSCell ID in a case where the condition is to be used.

Opt 3. A condReconfig id is allocated to each candidate target PSCell, but apart from this, a source PSCell id and a target PSCell id in a case where the corresponding is to be used for each piece of condition information are separately allocated. The terminal may receive configuration including the structure, i.e., a conditional reconfiguration for SCPAC field and then store each piece of information. Opt.3 has the following characteristics.
A new structure
A source PSCell id and a target PSCell id has a pre-defined integer and a network may inform the terminal of mapping information of an actual physical cell identity (PCI)/absolute radio frequency channel number (AFRCN) of each cell. For example, a condReconfig id allocated to each candidate target PSCell may be reused.
Alternatively, the source/target PSCell id may be information of a combination of the AFRCN and the PCI/cell group identity(CGI)/measurement object, instead of an id of an natural number.
In this case, the terminal may consider, as conditions to be evaluated, conditions in which a current PSCell of the terminal is matched to a source cell of each condition, at a time point at which subsCPAC execution is performed or the conditional reconfiguration for SCPAC configuration is received.

In the above-described options (Opt 1-1, Opt 1-2, Opt 1-3, Opt 2-1, Opt 2-2, Opt 2-3, and Opt 3), when a change from a specific source PSCell to a target PSCell cannot be performed, that is, when a candidate SN operated in the target PSCell does not perform admission of the change of the corresponding terminal, an NIN for providing a conditional reconfiguration for SCPAC configuration may make the corresponding condition part empty.

In this method, a null indicator may be included at the location of the corresponding condition. Alternatively, according to the suggested method of each option, an ID of the source PSCell and/or the target PSCell may be assigned to the null indicator. When condition information subject to condition evaluation by the terminal is null according to the options, the terminal may not evaluate the condition the corresponding condition does not exist.

Issue 2: After reception of the configuration information, a process of selectively evaluating a condition by the terminal is required. With respect to the options of Issue 1 above, a condition to be evaluated has already been mentioned, but the condition may be also represented as follows.

For the terminal transfer and measurement/evaluation scheme of a condition of subsCPAC of multiple conditions, in the measurement operation, measurement on the basis of an MO (A subset of this MO is a frequency of a target PSCell) included in measConfig of the corresponding condition is performed while applying a specific target PSCell configuration.

In the evaluation operation, unlike the existing case, evaluation on all conditions is not performed for condReconfigAddMod, but the evaluation may need to be selectively performed with reference to a current PSCell among the subsCPAC configuration (conditional reconfiguration for SCPAC) (or within a variable for storing the configuration).
Opt 1-1: When a condReconfiguration field is received and a configuration for a condReconfig id associated with addmod of the corresponding field is received, subsCPAC is performed, and then the terminal may select, for target PSCell ID value X matched to the current PSCell, from among respective entering condition lists remaining after excluding a list associated with the ID, the (X−1)^{th} condition in a list having an ID smaller than X and the X^{th} condition having an ID greater than X. Thereafter, the terminal may evaluate the selected conditions.
Opt 1-2: When a condReconfiguration field is received and a configuration for an id associated with addmod of the corresponding field is received, subsCPAC is performed, and then the terminal may evaluate conditions in which an ID for the source PSCell indicates the current PSCell, among the respective entering condition lists.
Opt 1-3: When a condReconfiguration field is received and a configuration for an id associated with addmod of the corresponding field is received, subsCPAC is performed, and then the terminal evaluates conditions in which source PSCell information indicates the current PSCell, among the respective entering condition lists.
Opt 2-1: When a condReconfiguration field is received and a configuration for a condReconfig id associated with addmod of the corresponding field is received, subsCPAC is performed, and then the terminal selects, for target PSCell ID value X matched to the current PSCell, all conditions of a list associated with the ID. The terminal evaluates the selected conditions.
Opt 2-2: The same as Opt 2-1
Opt 2-3: The same as Opt 2-1
Opt 3: When a condReconfiguration field is received and a configuration for a condReconfig id associated with addmod of the corresponding field is received, subsCPAC is performed, and then the terminal may select all conditions in which source PSCell information of each condition is identical to the current PSCell. The terminal may evaluate the selected conditions.

Issue 3: An add/mod/release operation of each condition may be as follows for each option.
Opt 1-1: During a mod/release operation, a network may indicate a corresponding target condition by a combination of a condReconfig ID and an ID on an entering list. According to the combination of two IDs, the terminal may recognize the indicated condition and perform modification and releasing.
Opt 1-2: During a mod/release operation, a network may indicate a corresponding target condition by a combination of a condReconfig ID and source PSCell information on an entering list. According to the combination of two pieces of information, the terminal may recognize the indicated condition and perform modification and releasing.
Opt 1-3: During a mod/release operation, a network may indicate a corresponding target condition by a combination of a condReconfig ID and source PSCell information on an entering list. According to the combination of two pieces of information, the terminal may recognize the indicated condition and perform modification and releasing.
Opt 2-1: During a mod/release operation, a network may indicate a corresponding target condition by a combination of a condReconfig ID and an ID on a leaving list. According to the combination of two piece of information, the terminal may recognize the indicated condition and perform modification and releasing.
Opt 2-2: During a mod/release operation, a network may indicate a corresponding target condition by a combination of a condReconfig ID and target PSCell information on a leaving list. According to the combination of two pieces of information, the terminal may recognize the indicated condition and perform modification and releasing.
Opt 2-3: During a mod/release operation, a network may indicate a corresponding target condition by a combination of a condReconfig ID and target PSCell information on a leaving list. According to the combination of two pieces of information, the terminal may recognize the indicated condition and perform modification and releasing.
Opt 3: During a mod/release operation, a network may indicate a corresponding target condition by a combination of a given source PSCell id and target PSCell id. According to the combination of two pieces of information, the terminal may recognize the indicated condition and perform modification and releasing.

Issue 4: Operation of adding/modifying/releasing a target PSCell configuration

When a network (or a base station) transfers, to a terminal, a target PSCell configuration and a condition associated therewith, which may have never been transferred before, by using the above-described structures, the network perform the transferring by allocating a condReconfig ID. Thereafter, when the network changes or removes the target PSCell configuration of the corresponding ID or the associated conditions, the network may indicate a condReconfig ID to be changed to removed so as to indicate the terminal to change a target PSCell configuration corresponding to the corresponding ID or change a condition corresponding to the corresponding ID, and remove the target PSCell configuration and condition.

In the methods of Opts. 1, 2, and 3, it has been proposed that the subsequent CPAC configuration is signaled to a subCPAC-specified independent field (referred to as “condition reconfiguration for SCPAC” above) in RRCReconfiguration transmitted from the base station.

On the other hand, a configuration related to the existing conditional reconfiguration (for legacy) field may be included and transferred. For example, a condition and a target PSCell configuration are included in an entry corresponding to one condReconfig ID of the existing conditional reconfiguration for legacy, and in addition to the entry, an entry including a specific row or a specific condReconfig ID for SCPAC among the conditional reconfiguration for SCAPC proposed in the Opts. 1, 2, and 3 may be included.

For example, one entry of the conditional reconfiguration for legacy may include the following: condReconfig ID 1, condition 1, target PSCell 1, SCPAC config {condReconfig ID for SCPAC, target PSCell configuration for SCPAC, list of conditions}.

In this case. The target PSCell configuration for SCPAC within SCPAC config may be substituted by the target PSCell configuration on the entry of the legacy structure and omitted. That is, in the example above, the target PSCell configuration on the legacy entry may be substituted by the target PSCell configuration for SCPAC of SCPAC config and the target PSCell configuration for SCPAC may be omitted. However, a method for recognizing and using the substituted target PSCell configuration is identical to those in the previous Opts. 1, 2, and 3.

According to another embodiment of the disclosure, separate target PSCell configuration information may be allocated to each element of a list of conditions. In the description in the previous Opts. 1, 2, and 3, the same target PSCell configuration is used during changing to one PSCell under the assumption that that the same specific target PSCell configuration is used regardless of a source cell from which the changing is performed or a target cell to which the changing is performed, but a full configuration is possible in this case.

If the target PSCell configuration is signaled as a delta configuration compared to each source PSCell, rather than a full configuration, target PSCell configuration information to be used during changing from a specific source PSCell to a specific target PSCell may vary. Accordingly, target PSCell configuration information to be applied to a source PSCell and a target PSCell may be associated with an element condition of the list of conditions of each of Opts. 1, 2, and 3, and the network may signal the same to the terminal. Based on the signaling, when the terminal receive the signal of the methods of the respective Opts. 1, 2, and 3, instead of applying the existing target PSCell configuration, the terminal may apply a separate target PSCell configuration associated with the corresponding condition when the terminal's own condition is satisfied.

In additional example, when there is no separate target PSCell configuration made for elements of the list of conditions, or when a full configuration indicator exists, the terminal may apply the target PSCell configurations on the existing Opts. 1, 2, and 3.

For the methods of Opts. 1, 2, and 3, there may be another embodiment for a condition measurement and evaluation operation, specifically, an operation of selecting and removing a condition from among the pieces of given condition information.

The condReconfig ID, the target cell configuration information, and configuration information including the list of cells, that is, a conditional reconfiguration for SCPAC field may need to be always maintained for the terminal, without being released for each PSCell change. Accordingly, when the pieces of configuration information, i.e., the subsequent CPAC configuration information is transferred to the terminal, the terminal may store the corresponding information in a separate variable (which may be referred to as a “long term variable”). In the disclosure, compared to the long term variable, a short term variable for separately maintaining condition information based on a current PSCell is proposed.

Whenever a PSCell of subsequent CPAC changes, a corresponding source cell is changed, accordingly, a condition for a specific target cell varies, and a condition measurement and evaluation operation is determined. To implement such an operation, the terminal may store, at a time point at which the subsequent CPAC configuration is received, the corresponding configuration in the long_term variable. In addition, the terminal may select pieces of condition information for a PSCell change to other candidate PSCells while a current PSCell is a source cell, and store the same separately in the short_term variable.

For example, the terminal may store, in the short term variable, target cell indication information of each list element and a leaving condition list based on the current PSCell in Opt. 2. That is, information related to other PSCells rather than the current PSCell may not be included in the short term variable.

When the terminal performs a PSCell change by subsequent CPAC or a normal PSCell change, all entries of the existing short term variable or an entry related to the subsequent CPAC may be released.

In addition, the terminal may newly store, in the short terminal variable, target cell indication information of each list element condition and a leaving condition list in which a target PSCell of a PSCell change is a source cell in the long term variable.

In the condition evaluation operation mentioned in the disclosure, the terminal recognizes a condition to be evaluated from a given configuration, and identifies a target cell associated with the corresponding condition. This identification process means recognizing a frequency and PCI of a target ell included in a reconfigurationWithSync field corresponding to SCG configuration information of a target PSCell configuration on an associated condReconfig ID, and performing conditional event evaluation operation for the corresponding cell.

Relatively, it is assumed in the PSCell measurement operation for condition evaluation that a current PSCell measurement configuration is made by a network. For example, a combination of a measurement object corresponding to the frequency of the target PSCell and reportConfiguration including a conditional event configuration may be included in the current PSCell measurement configuration, and a measurement ID by the combination of the MO and reportConfig may be condition information continuously mentioned in the disclosure.

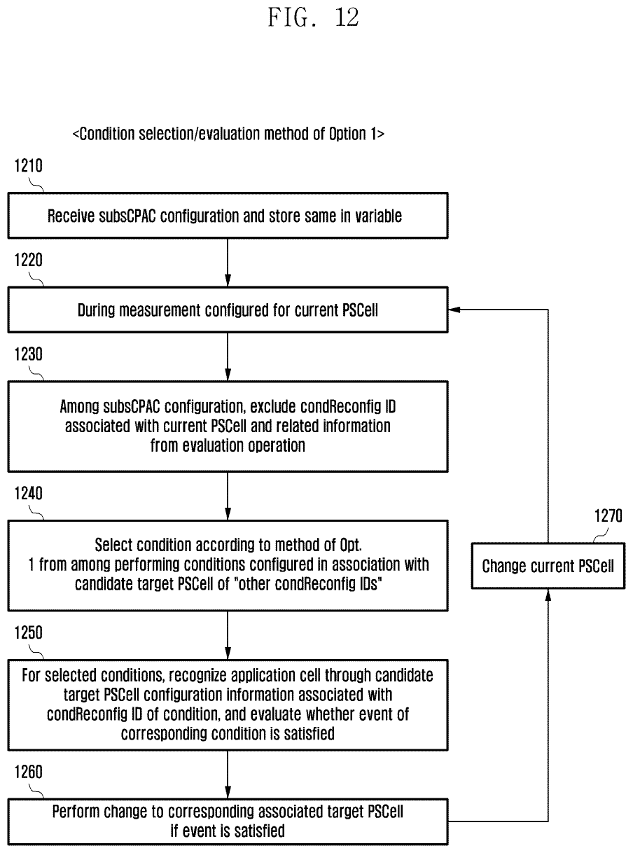

FIG. 12 illustrates a flow chart of an operation of a terminal according to an embodiment of the disclosure.

More specifically, FIG. 12 illustrates a method for selecting and evaluating a condition in the above-described case of Opt 1. Option 1 is a case where an entering condition and a condReconfig ID are combined and configured.

In operation 1210, a terminal may receive, from a network (or a base station), a subsCPAC configuration (or subsCPAC configuration information or subsCPAC config) and store the information in a variable. The subsCPAC configuration information may be included in a radio resource control (RRC) message (e.g., an RRCReconfiguration message) and transmitted to the terminal.

In operation 1220, the terminal may perform measurement according to a measurement configuration (or measurement information) included in the RRCReconfiguration message including the subsCPAC configuration.

In operation 1230, as an operation of selecting a condition for evaluation, a condition list (e.g., an entering condition list) on a condReconfig ID associated with a current PSCell may be first excluded.

In operation 1240, among the condition lists (for example entering condition lists) on the remaining condReconfig IDs, conditions in which the current PSCell is indicated as a source PSCell are selected and the other conditions may be also excluded.

In operation 1250, for the selected conditions, the terminal may recognize an application cell from target PSCell configuration information of a condReconfig ID associated with the selected conditions, and start condition evaluation based on the corresponding cell after the recognition.

In operation 1260, the terminal may perform changing to the target PSCell associated with the corresponding condition when there is a satisfied condition during the condition evaluation.

Thereafter, in operation 1270, the terminal newly applies a PSCell configuration while performing the changing to the target PSCell. In this case, the terminal may perform measurement by applying a new measurement configuration in the changed PSCell configuration. Thereafter, the terminal may perform again a condition selection and evaluation operation.

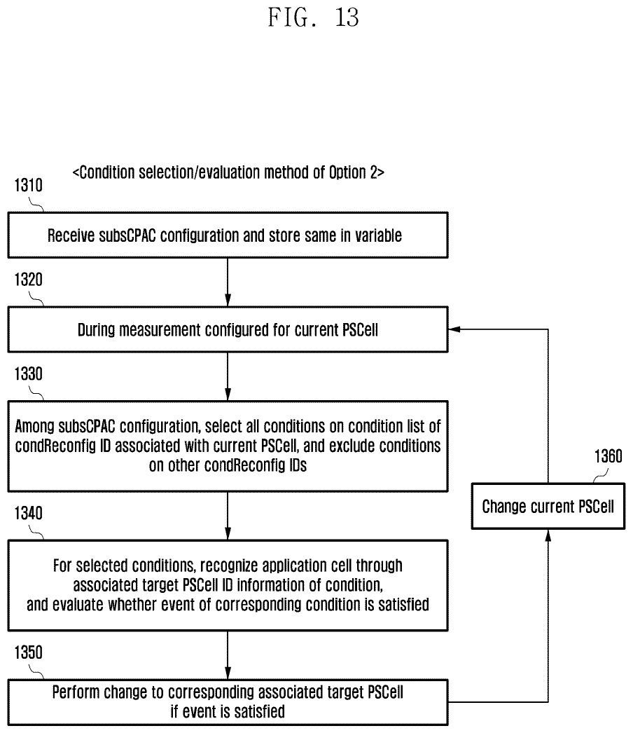

FIG. 13 illustrates a flow chart of an operation of a terminal according to another embodiment of the disclosure.

More specifically, FIG. 13 illustrates a method for selecting and evaluating a condition in the above-described case of Opt 2. Option 2 is a case where a leaving condition and a condReconfig ID are combined and configured.

In operation 1310, a terminal may receive, from a network (or a base station), a subsCPAC configuration (or subsCPAC configuration information or subsCPAC config) and store the information in a variable. The subsCPAC configuration information may be included in a radio resource control (RRC) message (e.g., an RRCReconfiguration message) and transmitted to the terminal.

In operation 1320, the terminal may perform measurement according to a measurement configuration (or measurement information) included in the RRCReconfiguration message including the subsCPAC configuration.

In operation 1330, as an operation of selecting a condition for evaluation, all conditions of condition lists (e.g., leaving condition lists) on a condReconfig ID associated with a current PSCell may be selected. The condition lists on the remaining condReconfig IDs may be all excluded.

In operation 1340, for the selected conditions, the terminal may recognize the corresponding target PSCell as an application cell from target PSCell ID information associated with the selected conditions, and start condition evaluation based on the corresponding cell after the recognition.

In operation 1350, the terminal may perform changing to the target PSCell associated with the corresponding condition when there is a satisfied condition during the condition evaluation.

Thereafter, in operation 1360, the terminal newly applies a PSCell configuration while performing the changing to the target PSCell. In this case, the terminal may perform measurement by applying a new measurement configuration in the changed PSCell configuration. Thereafter, the terminal may perform again a condition selection and evaluation operation.

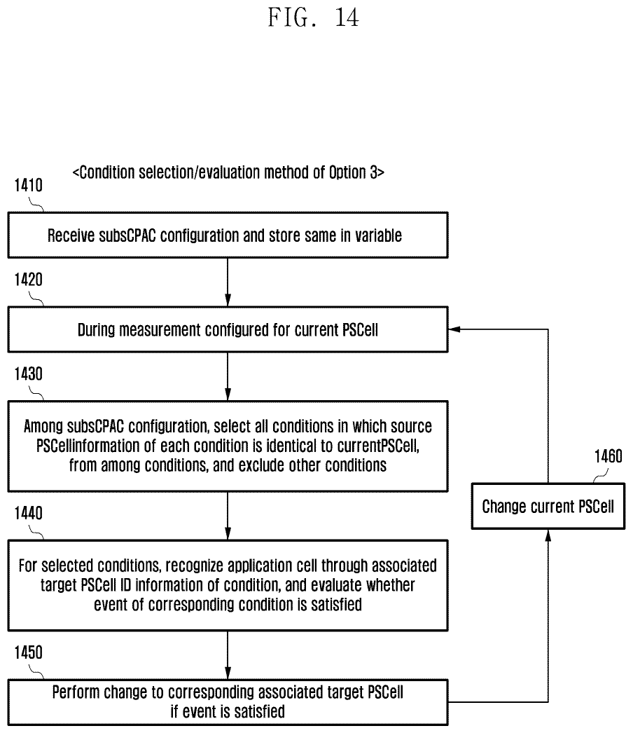

FIG. 14 illustrates a flow chart of an operation of a terminal according to yet another embodiment of the disclosure.

More specifically, FIG. 14 illustrates a method for selecting and evaluating a condition in the above-described case of Opt 3. Option 3 is a case where apart from a condReconfig ID, each condition has information on a source PSCell and a target PSCell in which each condition itself is to be used.

In operation 1410, a terminal may receive, from a network (or a base station), a subsCPAC configuration (or subsCPAC configuration information or subsCPAC config) and store the information in a variable. The subsCPAC configuration information may be included in a radio resource control (RRC) message (e.g., an RRCReconfiguration message) and transmitted to the terminal.

In operation 1420, the terminal may perform measurement according to a measurement configuration (or measurement information) included in the RRCReconfiguration message including the subsCPAC configuration.

In operation 1430, as an operation of selecting a condition for evaluation, and when source PSCell information of each of the conditions is matched to a current PSCell, the corresponding conditions are selected, and the other conditions may be all excluded.

In operation 1440, for the selected conditions, the terminal may recognize the corresponding target PSCell as an application cell from target PSCell ID information associated with the selected conditions, and start condition evaluation based on the corresponding cell after the recognition.

In operation 1450, the terminal may perform changing to the target PSCell associated with the corresponding condition when there is a satisfied condition during the condition evaluation.

In operation 1460, the terminal newly applies a PSCell configuration while performing the changing to the target PSCell. In this case, the terminal may perform measurement by applying a new measurement configuration in the changed PSCell configuration. Thereafter, the terminal may perform again a condition selection and evaluation operation.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

In addition, the programs may be stored in an attachable storage device which can access the electronic device through communication networks such as the Internet, Intranet, Local Area Network (LAN), Wide LAN (WLAN), and Storage Area Network (SAN) or a combination thereof. Such a storage device may access the electronic device via an external port. Also, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

Although specific embodiments have been described in the detailed description of the disclosure, it will be apparent that various modifications and changes may be made thereto without departing from the scope of the disclosure. Therefore, the scope of the disclosure should not be defined as being limited to the embodiments set forth herein, but should be defined by the appended claims and equivalents thereof.

What is claimed is:

1. A method performed by a user equipment (UE) supporting a subsequent conditional primary secondary cell group (SCG) cell (PSCell) addition and change (CPAC) (SCPAC) in a wireless communication system, the method comprising:
receiving, from a base station, conditional reconfiguration information including candidate target PSCell configuration information for a first target PSCell and at least one SCPAC configuration information corresponding to the first target PSCell;
based on the conditional reconfiguration information, identifying whether an execution condition associated with a CPAC for the first target PSCell is fulfilled; and
in case that the execution condition associated with the CPAC for the first target PSCell is fulfilled, applying a RRC reconfiguration message for the first target PSCell.

2. The method of claim 1,
wherein the candidate target PSCell configuration information for the first target PSCell includes a identifier for the first target PSCell, first execution condition information for the CPAC associated with the first PSCell, and the RRC reconfiguration message to be applied when the execution condition is fulfilled.

3. The method of claim 1,
wherein each SCPAC configuration information among the at least one SPCAC configuration information corresponding to the first target PSCell includes a identifier for a second target PSCell, and second execution condition information for the SCPAC.

4. The method of claim 1, the method further comprising:
storing the conditional reconfiguration information for the first target PSCell to a UE variable.

5. The method of claim 1, the method further comprising:
performing a SCPAC execution for a second target PSCell based on stored SCPAC configuration information.

6. A method performed by a base station supporting a subsequent conditional primary secondary cell group (SCG) cell (PSCell) addition and change (CPAC) (SCPAC) in a wireless communication system, the method comprising:
generating conditional reconfiguration information including candidate target PSCell configuration information for a first target PSCell and at least one SCPAC configuration information corresponding to the first target PSCell; and
transmitting, to a user equipment (UE), the conditional reconfiguration information including the candidate target PSCell configuration information for the first target PSCell and the at least one SCPAC configuration information corresponding to the first target PSCell,
wherein in case that an execution condition associated with a CPAC for the first target PSCell is fulfilled, a RRC reconfiguration message for the first target PSCell is applied.

7. The method of claim 6,
wherein the candidate target PSCell configuration information for the first target PSCell includes a identifier for the first target PSCell, first execution condition information for the CPAC associated with the first PSCell, and the RRC reconfiguration message to be applied when the execution condition is fulfilled.

8. The method of claim 6,
wherein each SCPAC configuration information among the at least one SPCAC configuration information corresponding to the first target PSCell includes a identifier for a second target PSCell, and second execution condition information for the SCPAC.

9. The method of claim 6,
wherein the conditional reconfiguration information for the first target PSCell is stored to a UE variable.

10. The method of claim 9,
wherein a SCPAC execution for a second target PSCell is performed based on stored SCPAC configuration information.

11. A user equipment (UE) supporting a subsequent conditional primary secondary cell group (SCG) cell (PSCell) addition and change (CPAC) (SCPAC) in a wireless communication system, the UE comprising:
a transceiver; and
a controller configured to:
receive, from a base station, conditional reconfiguration information including candidate target PSCell configuration information for a first target PSCell and at least one SCPAC configuration information corresponding to the first target PSCell,
based on the conditional reconfiguration information, identify whether an execution condition associated with a CPAC for the first target PSCell is fulfilled, and
in case that the execution condition associated with the CPAC for the first target PSCell is fulfilled, apply a RRC reconfiguration message for the first target PSCell.

12. The UE of claim 11,
wherein the candidate target PSCell configuration information for the first target PSCell includes a identifier for the first target PSCell, first execution condition information for the CPAC associated with the first PSCell, and the RRC reconfiguration message to be applied when the execution condition is fulfilled.

13. The UE of claim 11,
wherein each SCPAC configuration information among the at least one SPCAC configuration information corresponding to the first target PSCell includes a identifier for a second target PSCell, and second execution condition information for the SCPAC.

14. The UE of claim 11, wherein the controller is further configured to:
store the conditional reconfiguration information for the first target PSCell to a UE variable.

15. The UE of claim 11, wherein the controller is further configured to:
perform a SCPAC execution for a second target PSCell based on stored SCPAC configuration information.

16. A base station supporting a subsequent conditional primary secondary cell group (SCG) cell (PSCell) addition and change (CPAC) (SCPAC) in a wireless communication system, the base station comprising:
a transceiver; and
a controller configured to:
generate conditional reconfiguration information including candidate target PSCell configuration information for a first target PSCell and at least one SCPAC configuration information corresponding to the first target PSCell, and
transmit, to a user equipment (UE), the conditional reconfiguration information including the candidate target PSCell configuration information for the first target PSCell and the at least one SCPAC configuration information corresponding to the first target PSCell,
wherein in case that an execution condition associated with a CPAC for the first target PSCell is fulfilled, a RRC reconfiguration message for the first target PSCell is applied.

17. The base station of claim 16,
wherein the candidate target PSCell configuration information for the first target PSCell includes a identifier for the first target PSCell, first execution condition information for the CPAC associated with the first PSCell, and the RRC reconfiguration message to be applied when the execution condition is fulfilled.

18. The base station of claim 16,
wherein each SCPAC configuration information among the at least one SPCAC configuration information corresponding to the first target PSCell includes a identifier for a second target PSCell, and second execution condition information for the SCPAC.

19. The base station of claim 16,
wherein the conditional reconfiguration information for the first target PSCell is stored to a UE variable.

20. The base station of claim 16,
wherein a SCPAC execution for a second target PSCell is performed based on stored SCPAC configuration information.
